(19) United States
(12) Patent Application Publication
(10) Pub. No.: US 2017/0320149 A1
(43) Pub. Date: Nov. 9, 2017

(54) SLIDE BLOCK FOR A SAW BAND IN A BANDSAW MACHINE

(71) Applicant: FREUND Maschinenfabrik GmbH & Co. KG, Paderborn (DE)

(72) Inventor: Robert FREUND, Paderborn (DE)

(73) Assignee: FREUND Maschinenfabrik GmbH & Co. KG, Paderborn (DE)

(21) Appl. No.: 15/585,625

(22) Filed: May 3, 2017

(30) Foreign Application Priority Data
May 3, 2016 (DE) 20 2016 102 339.4

(51) Int. Cl. B23D 55/08

(52) U.S. Cl. CPC B23D 55/082

(57) ABSTRACT

A slide block for a saw band in a bandsaw machine, which is disposed as a pair at a distance to one another and between said pair a slot is present, through which the saw band is guided, and the frictional forces of the running saw band are absorbed on the edges of the slide blocks, whereby the slide block is made of a hard ceramic.

This nonprovisional application claims priority under 35 U.S.C. §119(a) to German Patent Application No. 20 2016 102 339.4, which was filed in Germany on May 3, 2016, and which is herein incorporated by reference.

### BACKGROUND OF THE INVENTION

### Field of the Invention

The invention relates to a slide block for a saw band in a bandsaw machine, which is disposed as a pair at a distance to one another and between said pair a slot is formed, through which the saw band is guided, and the frictional forces of the running saw band are absorbed on the edges of the slide blocks.

### Description of the Background Art

Bandsaws of various designs are used. In these bandsaws, a continuous saw band is guided with a side surface on the circumference of two wheels. In the freely running part of the saw band, the so-called cutting segment, the saw band is guided by two slide blocks which are disposed at a distance to one another and leave the sawing region free, so as to saw the particular workpiece. In this regard, the saw band can also be rotated by 90° in the cutting segment so as to achieve a desired cutting plane. In so doing, the band guides make sure that before entering the workpiece to be sawn and after leaving it, the saw band is rotated in the cutting plane or rotated back out of the cutting plane into the rotary position.

The band guides are typically equipped with hard metal bodies or rollers. It was determined during operation of a band guide of this type that the hard metal bodies and the saw band are subjected to increased wear in the area of the sliding contact surface. Said wear results in a greatly increased heat development due to a greatly increased friction. This results in a decrease of the side guiding of the saw band and a more rapid wear of the saw band.

Patent application DE 38 13 352 A1 describes a bandsaw in which the guiding of the saw band, also in the case of a possible pivoting of the cutting segment, occurs via a roller assembly.

Patent application DE 10 2008 044 669 A1, which corresponds to U.S. Pat. No. 8,240,236, describes one-piece guide plates for a bandsaw, which are made of a hard metal. These guide plates are not suitable for rotating the saw blade in a rotated sawing direction.

Patent U.S. Pat. No. 6,202,528 B1 describes slide blocks, arranged in pairs, for a saw band. These slide blocks are made of a carbide material. The guiding of the back of the saw band occurs via a metal roller.

Patent U.S. Pat. No. 4,920,846 describes guide blocks for a saw band. The material of the guide blocks is a fabric of fiber-reinforced and graphite-impregnated phenolic resin. In the regard, the guide block can also have a number of laminated layers.

### SUMMARY OF THE INVENTION

It is therefore an objection of the present invention to provide slide blocks that are sufficiently hard to ensure a long service life of the saw band and of the slide blocks as well. This should also apply in the case of increased frictional forces caused by a saw band rotated by 90°.

In an exemplary embodiment, the slide block is provided for a saw band in a bandsaw machine. In this regard, two slide blocks are disposed as a pair at a distance to one another such that a slot is present between them through which the saw band is guided. The frictional forces of the running saw band are absorbed on the edges of the slide blocks.

The slide block can be made of a hard ceramic.

Tests have shown that a long service life of the frictional saw band is achievable with the hard ceramic. The service life of a slide block of this type is also longer than if it were to be made of hard metal.

Various hard ceramics are available for such a slide block.

Aluminum oxide is suitable as a material. Silicon nitride is likewise suitable.

These materials are very hard. They have a Vickers hardness greater than 1600 HV 0.5.

The two slide blocks of the pair are advantageously made as symmetric prisms each with two parallel sliding surfaces, such that a middle part of the side of the saw band slides along them. In this case, the sliding surfaces stand vertically on a bottom surface and thereby also on a top surface of the prisms.

The rotary saw band rubs on the sliding surfaces. They are kept so short that to prevent thermal stress the toothless band back of the saw band is not in contact with the slide blocks.

The two edges of the sliding surfaces are advantageously rounded off relative to the bottom surface and the top surface, such that the torsional forces arising during a pivoting of the saw band are absorbed more widely.

For attaching the slide blocks to a guide plate, these have in their vertical axis two holes located at a distance to one another. The slide blocks can also be inserted slightly rotated with thus placed holes and thereby the further edges can be used after the first edges are worn.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a saw band guided between two slide blocks; and

FIG. 2 shows a slide block in an isometric view.

### DETAILED DESCRIPTION

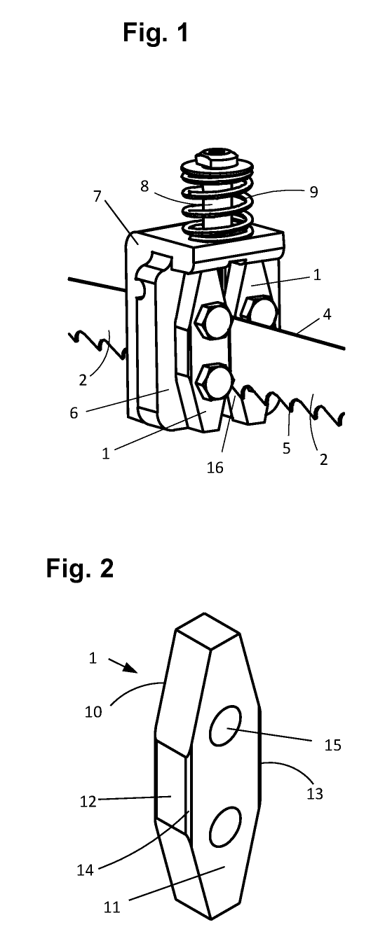

FIG. 1 shows a continuous rotary saw band 2 that is guided between two slide blocks 1 in slot 16. Slide blocks 1 are screwed as a pair onto a guide plate 6, which in turn is attached to a carriage 7 and a bolt 8 with a spring 9 in a bandsaw.

Slide blocks are made prism-shaped with side sliding surfaces, which are so short that band back 4 and band serration 5 during rotation do not rub against slide blocks 1.

FIG. 2 shows a slide block 1 in an isometric view. It is formed in the shape of a prism and has the two sliding surfaces 12 and 13, each of which have an edge 14 that is rounded off both relative to bottom surface 10 and top surface 11.

Holes 15 are disposed symmetrically, so that the slide block can be screwed on in all directions and thereby all edges 14 can be used one after the other.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A slide block for a saw band arranged in a bandsaw machine, which is disposed as a pair at a distance to one another and between said pair a slot is present, through which the saw band is guided, wherein frictional forces of the running saw band are absorbed on edges of the slide blocks, and wherein the slide block is made of a hard ceramic.

2. The slide block according to claim 1, wherein the hard ceramic is an aluminum oxide.

3. The slide block according to claim 1, wherein the hard ceramic is a silicon nitride.

4. The slide block according to claim 1, wherein , the hard ceramic has a Vickers hardness greater than 1600 HV 0.5.

5. The slide block according to claim 1, wherein both slide blocks of the pair are made as symmetric prisms each with two parallel sliding surfaces such that a middle part of the side of the saw band slides along them, wherein the sliding surfaces stand vertically on a bottom surface and thereby also on a top surface of the prisms.

6. The slide block according to claim 1, wherein two edges of the sliding surfaces are rounded off relative to the bottom surface and to the top surface such that the torsional forces arising during a pivoting of the saw band are absorbed.

7. The slide block according to claim 1, wherein, to prevent thermal stress, the saw band at its toothless band back is not in contact with the slide blocks.

8. The slide block according to claim 1, wherein, in its vertical axis, the slide block has two holes located at a distance to one another.
